(19) United States
(12) Patent Application Publication
(10) Pub. No.: US 2009/0098788 A1
(43) Pub. Date: Apr. 16, 2009

(54) PLASMA DISPLAY PANEL AND MANUFACTURING METHOD THEREOF

(76) Inventors: Yuichi Sawai, Miyazaki (JP); Hideki Harada, Miyazaki (JP); Masashi Nishiki, Miyazaki (JP); Tetsuro Kawakita, Miyazaki (JP); Michifumi Kawai, Miyazaki (JP); Nobuhiko Hosotani, Miyazaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/019,695

(22) Filed: Jan. 25, 2008

(30) Foreign Application Priority Data
Oct. 12, 2007 (JP) 2007-266023

(51) Int. Cl. H01J 9/00

(52) U.S. Cl. 445/24

(57) ABSTRACT

In a plasma display panel where a discharge space is partitioned by lattice-shaped barrier rib which comprises vertical ribs and horizontal ribs, a manufacturing method for the plasma display panel is acquired. This manufacturing method is designed for allowing substantially-linear exhaustion-use through holes parallel to the vertical ribs to be formed on the horizontal ribs with the execution of a simple and convenient processing step. The plasma-display-panel manufacturing method thus acquired includes steps of forming a glass-containing material, which becomes step-difference, into a stripe-shaped configuration at positions of the vertical ribs on a coated film of a barrier rib material formed on a glass substrate, and after that, performing patterning of the lattice-shaped barrier rib.

### BACKGROUND OF THE INVENTION

1. Field of the Invention

The present invention relates to a plasma display panel and a manufacturing method thereof.

2. Description of the Related Art

A plasma display is an image display device of self light-emitting type. In the plasma display, a discharge space is formed in its inside by oppositely locating a pair of glass substrates with a microscopic clearance set therebetween, and sealing the surroundings of these substrates. The plasma display has a barrier rib to keep the microscopic clearance. As the barrier rib designed for the plasma display, there have been known a stripe-shaped barrier rib and a lattice-shaped barrier rib. In the stripe-shaped barrier rib, grooves are provided therein in parallel to each other. In the lattice-shaped barrier rib, the barrier rib is formed into a lattice-shaped configuration thereby to prevent an interference of the discharge between pixels. In the case of the stripe-shaped barrier rib, when implementing the display panel by sealing and bonding the barrier rib integrally with the oppositely-located glass substrates, air existing inside the display panel can be exhausted out of the sealed portion via the grooves. Meanwhile, in the case of the display panel using the lattice-shaped barrier rib, the exhaustion becomes difficult at the time of the sealing/bonding and exhaustion for the implementation of the panel. Accordingly, various ingenious ideas have been devised in order to provide exhaustion-use through holes for facilitating the exhaustion.

In JP-A-2006-216525, after manufacturing the lattice-shaped barrier rib temporarily, e.g., a barrier-rib-use paste is formed at the top portions of vertical ribs up to a predetermined height by using a direct patterning method. The direct patterning method is defined as either an inkjet method or a dispensing method.

In JP-A-2006-210069, a concave-convex pattern is provided on a front-surface plate by forming the cross section of a bus electrode of the front-surface plate into an arc-like configuration, and making a dielectric layer thin. Then, clearances, which are created when the front-surface plate is combined with a rear-surface plate on which the lattice-shaped barrier rib is formed, are employed and utilized as the exhaustion-use exhaustion channels.

In JP-A-2005-285710, a first-layer photosensitive paste is coated, then being exposed to light with a stripe pattern. Next, a second-layer photosensitive paste is coated. Moreover, the pattern of a portion in which height of the vertical ribs becomes higher is exposed to light, then being developed. In this way, the barrier rib having a difference in height is formed. The difference in the height is adjusted, depending on type of the paste coated on the second layer and its coated film thickness.

In JP-A-2006-73344, there is disclosed a technique for simultaneously forming the barrier rib and the exhaustion-use through holes by etching a metallic plate from both sides with different patterns.

In JP-A-2006-216536, the barrier-rib-use paste is coated on the rear substrate, then performing the patterning of the barrier rib in such a manner that its width differs between the vertical direction and the horizontal direction. Moreover, after forming the barrier rib using a sandblast processing, an etching solution is coated thereon. Then, taking advantage of a difference in the etching amount due to the difference in the pattern width, a difference in height is formed between the vertical ribs and the horizontal ribs. This difference in the height is employed and utilized as the exhaustion-use exhaustion channels.

In JP-A-2006-210344, at a firing step for the barrier rib, taking advantage of a difference in the shrinkage amount between the vertical ribs and the horizontal ribs caused by the firing, a difference in height is formed between the vertical ribs and the horizontal ribs. This difference in the height is employed and utilized as the exhaustion-use exhaustion channels.

In the technique of JP-A-2006-216525, there is a necessity for performing the patterning of the barrier-rib-use paste only to the top portions of the vertical ribs of the lattice-shaped barrier rib. This necessity necessitates implementation of an exceedingly high-accuracy patterning method. As a result, the processing steps become complicated. In addition thereto, if the accuracy of the patterning method is low, the barrier-rib-use paste intrudes into the inner side of the lattice-shaped barrier rib. Accordingly, in some cases, it becomes impossible to provide the exhaustion-use exhaustion channels.

In the technique of JP-A-2006-210069, since the dielectric layer must be formed thinly, the degree of freedom of design is low. Also, in such a dielectric layer, in some cases, the dielectric layer on the bus electrode comes into contact with the barrier rib at the time of the sealing/bonding and exhaustion, thereby being damaged.

In the technique of JP-A-2005-285710, in addition to the use of the plurality of photosensitive pastes, the two-times light-exposure steps are required. This situation brings about an increase in the cost.

In the technique of JP-A-2006-73344, the material of the barrier rib is limited to a metallic material whose handling is easy to perform. After simultaneously forming the barrier rib and the exhaustion-use through holes by etching the metallic plate, there is a necessity for pasting the barrier rib on the glass substrates with no clearance therebetween, and coating the surface with an insulating material. This situation makes the processing steps complicated and difficult.

In the technique of JP-A-2006-216536, the difference in the height, which is formed by taking advantage of the difference in the etching amount due to the difference in the pattern width, is employed and utilized as the exhaustion-use exhaustion channels. In this technique, however, it is difficult to form the entire-area exhaustion-use exhaustion channels into an equal size. Also, it is lost to implement the degree of freedom of designing the configuration of the barrier rib. In the technique of JP-A-2006-210344 as well, similarly, in addition to the fact that it is difficult to form the entire-area exhaustion-use exhaustion channels into an equal size, it is lost to implement the degree of freedom of designing the configuration of the barrier rib.

### SUMMARY OF THE INVENTION

It is an object of the present invention to provide a plasma-display-panel manufacturing method in which the exhaustion-use exhaustion channels can be provided with the execution of a simple and convenient processing step. Also, it is another object thereof to enhance the yield at the time of the manufacturing therefor, and to implement the simultaneous accomplishment of a performance enhancement and a cost down in the plasma display panel.

A feature of the present patent application for accomplishing the above-described objects is the following plasma-display-panel manufacturing method: Namely, a plasma-display-panel manufacturing method for forming a lattice-shaped barrier rib by the steps of providing a first barrier rib material layer on a glass substrate, providing second striped barrier rib material layers into a stripe-shaped configuration on the first barrier rib material layer, and after that, performing pattern formation of the lattice-shaped barrier rib in alignment with positions of the second striped barrier rib material layers.

A glass-containing material is formed into a stripe-shaped configuration on the coated film of a barrier rib material. Then, the patterning of the lattice-shaped barrier rib is performed such that the position of the barrier rib is aligned with the stripe position. Accordingly, the glass-containing material remains on the barrier rib. As a result, the step difference can be formed on either of vertical ribs and horizontal ribs of the lattice-shaped barrier rib. From the meaning like this, in the present specification, the stripe-shaped glass-containing material is referred to as the second striped barrier rib material layers. In the lattice-shaped barrier rib, it is preferable that a portion having the second striped barrier rib material layers is defined as the position of the vertical ribs. Also, it is preferable that exhaustion-use through holes are included in the horizontal ribs.

The second striped barrier rib material layers are provided on the barrier ribs which are parallel to direction of the same-color phosphors. Also, the exhaustion-use through holes are provided on the barrier ribs which are perpendicular to the direction of the same-color phosphors. In an ordinary image display device, when red, green, and blue phosphors are inserted into respective cells formed by the lattice-shaped barrier rib, the phosphors of the respective cells are set to be the same color in the vertical direction. Consequently, by implementing a barrier-rib configuration where the second striped barrier rib material layers are provided on the vertical ribs, and does not pass through in the horizontal direction, it becomes possible to prevent a leakage of the phosphors into horizontally-adjacent cells. In this case, the exhaustion-use through holes are provided in the horizontal ribs.

It is preferable that the second striped barrier rib material layers are composed of a glass-containing material. The reason for this is as follows: When the first barrier rib material layer, i.e., a ground substrate, is composed of glass, the glass of the glass-containing material is softened and melted at a firing step, thereby being integrated into the first barrier rib material layer, i.e., the ground substrate. This is because of the above-described condition that the second striped barrier rib material layers are composed of the glass-containing material.

At the step of providing the second striped barrier rib material layers into the stripe-shaped configuration, methods, such as screen printing method, metal mask method, dispenser method, and skijing dispenser method, are usable. Of these methods, the screen printing method is the simplest and most convenient one.

As a patterning method at the patterning step of patterning the lattice-shaped barrier rib, whatever method is applicable as long as it is a method of eliminating unnecessary portions of the first barrier rib material layer and the second striped barrier rib material layers thereby to form the pattern of the barrier rib. Accordingly, methods, such as sandblast method and chemical etching method, are applicable. In the methods such as sandblast method and chemical etching method, the patterning is performed using a resist material, and either of positive-type resist material and negative-type resist material is applicable as the resist material. It is preferable to select a resist material which is unlikely to be damaged even in the step-difference portion created on the stripe-shaped second striped barrier rib material layers, and which has a high-coverage property and allows coverage of the step-difference portion.

Executing the formation as described above makes it possible to provide the exhaustion-use exhaustion channels with the execution of the one-time patterning step. Accordingly, even in the case of the high-quality plasma display device where the discharge space is partitioned by the vertical ribs and the horizontal ribs, the manufacturing of the exhaustion-use through holes is implemented with the simple and convenient processing step, and thus becomes easier to execute. Consequently, this manufacturing method is effective in implementing the yield enhancement and cost reduction in the plasma display panel. Also, it becomes easier to adjust size of the through holes provided in the lattice-shaped barrier rib.

According to the above-described configuration, it becomes possible to form, with the simple and convenient processing step, the exhaustion-use exhaustion channels of the plasma display panel having the lattice-shaped barrier rib, and to provide the high-performance plasma display device.

Other objects, features and advantages of the invention will become apparent from the following description of the embodiments of the invention taken in conjunction with the accompanying drawings.

### BRIEF DESCRIPTION OF THE DRAWINGS

FIG. 1 is a schematic diagram of an example of the barrier-rib structure according to the present invention;

FIG. 2 is a structural schematic diagram of the barrier-rib structure in a case where second striped barrier rib material layers having a configuration of partially protruding in the horizontal ribs' direction are provided on the vertical ribs;

FIG. 3 is a structural schematic diagram of the barrier-rib structure in a case where the second striped barrier rib material layers whose widths are narrower than widths of upper bases of the vertical ribs are provided on the vertical ribs;

FIG. 4A and FIG. 4B are structural schematic diagrams of the barrier-rib structure in a case where a black pigment is contained into the second striped barrier rib material layers;

FIG. 5 is a structural schematic diagram of a black matrix which is formed on the side of a rear-surface plate, is continuous in an address-electrode direction, and is discontinuous in the direction perpendicular to the address electrode;

FIG. 6A, FIG. 6B, and FIG. 6C are diagrams for illustrating steps of forming the horizontal ribs having concave through holes;

FIG. 6D and FIG. 6E are diagrams for illustrating the steps of forming the horizontal ribs having the concave through holes;

FIG. 6F, FIG. 6G, and FIG. 6H are diagrams for illustrating the steps of forming the horizontal ribs having the concave through holes;

FIG. 6I, FIG. 6J, and FIG. 6K are diagrams for illustrating the steps of forming the horizontal ribs having the concave through holes;

FIG. 7A and FIG. 7B are structural schematic diagrams of the barrier rib and the second striped barrier rib material layers in a case where the patterning is performed using a chemical etching method; and

FIG. 8 is a diagram for illustrating the degrees of vacuum inside prototype panels in correspondence with size of the concave through holes.

### DESCRIPTION OF THE INVENTION

The lattice-shaped barrier rib partitions between pixels, thereby preventing an interference of the discharge therebetween. This feature makes the lattice-shaped barrier rib effective in implementing a high color-tone plasma display. In the plasma display, air existing inside of the panel needs to be exhausted temporarily up to a high vacuum before the inside is filled with a discharge gas. In the display having the lattice-shaped barrier rib, as compared with a display panel having a substantially-linear barrier rib, the air exhaustion is less likely and thus more difficult to achieve. This situation necessitates a longer time to implement the vacuum. It is desirable to implement the vacuum in a short time by providing high exhaustion-efficiency through holes onto the lattice-shaped barrier rib. However, the steps of providing the high exhaustion-efficiency exhaustion channels are complicated. This situation has necessitated extra time, labor, and cost. Accordingly, as a result of careful and deliberate investigation, the present inventor et al. have ingeniously devised the manufacturing steps for the barrier rib on the rear substrate, thereby finding out a simple and convenient methodology for forming the high exhaustion-efficiency through holes on the horizontal ribs. Consequently, hereinafter, the explanation will be given below concerning this methodology.

### Embodiment 1

First, in the present embodiment, the detailed explanation will be given below concerning configuration of the plasma display panel. The plasma display panel has a configuration that a front substrate and a rear substrate are oppositely located to each other. The front substrate includes components such as a plurality of electrodes and a dielectric layer which is so formed as to cover the plurality of electrodes. Also, the rear substrate includes components such as an address electrode and a barrier rib which forms discharge cells by partitioning the discharge cells. The barrier rib in the present embodiment is a lattice-shaped barrier rib which is constituted by vertical ribs parallel to the address electrode and horizontal ribs perpendicular to the address electrode. The barrier rib includes the lattice-shaped barrier rib constituted by the vertical ribs and the horizontal ribs having a substantially equal height, and second striped barrier rib material layers provided on the vertical ribs.

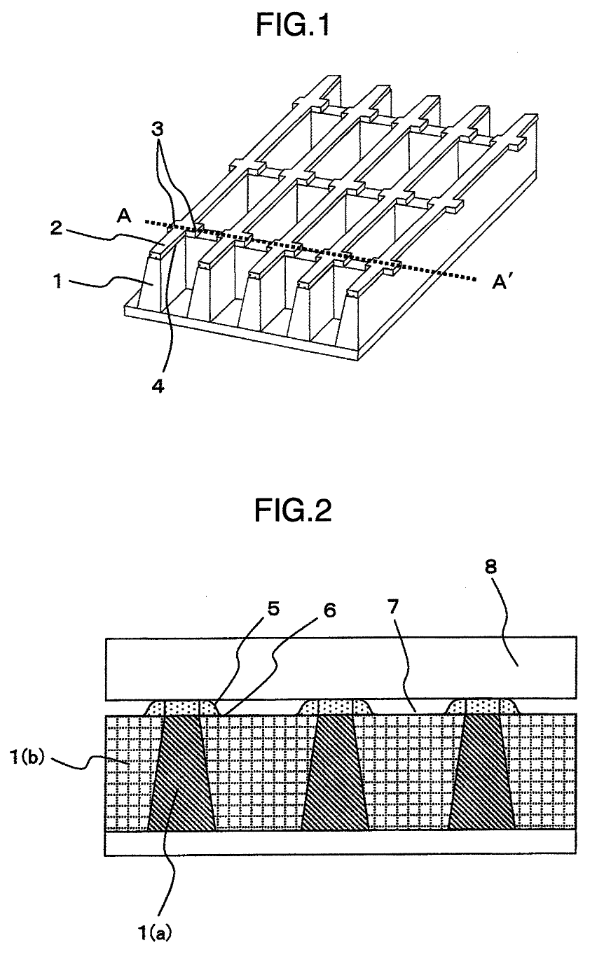

FIG. 1 schematically illustrates an example of the barrier-rib structure according to the present embodiment. The barrier rib of the present invention is composed of a glass-containing material. Also, the barrier rib is constituted by a lattice-shaped barrier rib 1 including vertical ribs and horizontal ribs having a substantially equal height, and second striped barrier rib material layers 2 provided on the vertical ribs. The second striped barrier rib material layers 2 have protrusion portions 3 in the horizontal ribs' direction. The protrusion portions 3 allow formation of concave portions of the second striped barrier rib material layers 2 on the horizontal ribs. Moreover, the concave portions result in formation of substantially-linear exhaustion-use through holes parallel to the vertical ribs. The formation of the exhaustion-use through holes makes the air exhaustion easier.

The protrusion portions 3 are formed as follows: Stripe widths of the second striped barrier rib material layers 2, which are composed of the glass-containing material formed into a stripe-shaped configuration, are made larger than widths of upper bases of the vertical ribs. Setting up the protrusion portions like this allows an enhancement in the support strength. Also, a certain extent of shift occurring at the time of forming the stripe presents no problem because of the set-up of the protrusion portions. Accordingly, it becomes possible to reduce the accuracy of steps (i.e., printing and the like) of providing the second striped barrier rib material layers into the stripe-shaped configuration.

Also, because of the set-up of the protrusion portions, widths of the concave through holes on the horizontal ribs can be made smaller than widths of the horizontal ribs. A paste of phosphor is printed inside the barrier rib, then being dried and fired. In the plasma display panel, it is desirable to increase the phosphor amount. Also, the firing step changes configuration of the phosphor into a configuration where center of the phosphor is made concave (i.e., configuration where corner portions of the barrier rib are higher). Consequently, the set-up of the protrusion portions, i.e., the corner portions of the barrier rib, reduces a possibility that the phosphor may flow off into the outside of the barrier rib. This feature makes it possible to increase the phosphor amount that the barrier rib retains. Also, it is preferable to cause the widths and height of the exhaustion-use through holes to coincide with the configuration of the phosphor inside the barrier rib.

FIG. 2 illustrates a structural schematic diagram of the lattice-shaped barrier rib 1 and the second striped barrier rib material layers 2 of the plasma display panel. FIG. 2 illustrates cross sections of edge portions of the protrusion portions 3 illustrated in FIG. 1. If the second striped barrier rib material layers are formed using the printing method with a fluidity-exhibiting paste, the edge portions of the second striped barrier rib material layers become smooth. As illustrated in FIG. 2, the configuration of each second striped barrier rib material layer becomes a configuration having a curvature, i.e., the configuration where, toward the inside of each through hole, each second striped barrier rib material layer has a convex surface denoted by a reference numeral 5 and a concave surface denoted by 6. A reference numeral 7 denotes each through hole which becomes each exhaustion channel. Namely, the wall surface of each through hole is formed into the surface of having the curvature toward the inside of each through hole. This formation brings about an effect of lowering a fluid friction coefficient at the time when air passes through each through hole at the time of the sealing/bonding and exhaustion. Also, having the curvature like this results in no corners, thus making it unlikely that each second striped barrier rib material layer may be destroyed at the time of the sealing or the like. This result is preferable enough.

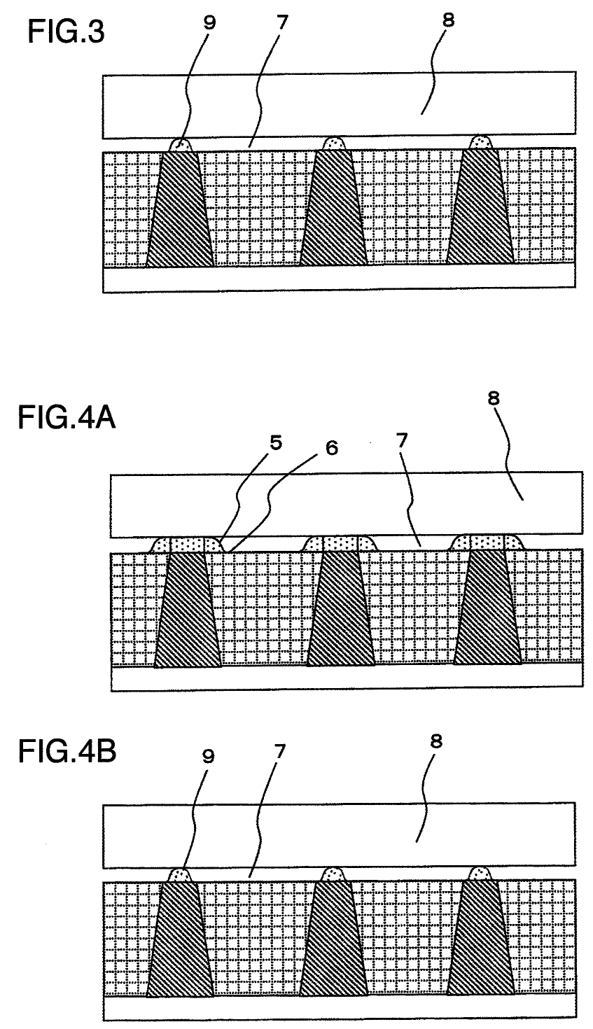

As illustrated in FIG. 3, the widths of the stripe-shaped second striped barrier rib material layers 2 are made narrower than the widths of the upper bases of the vertical ribs. This method also makes it possible to reduce the printing accuracy. In the case of FIG. 3, there exists none of the protrusion portions 3 illustrated in FIG. 1. The widths of the second striped barrier rib material layers 2 are narrower than the widths of the upper bases of the vertical ribs. The configuration of each second striped barrier rib material layer becomes a rounded-projection-shaped configuration as is represented by a reference numeral 9. A reference numeral 7 denotes each through hole which becomes each exhaustion channel. When the second striped barrier rib material layers are formed whose widths are narrower than the widths of the upper bases of the vertical ribs, the second striped barrier rib material layers are not necessarily required to be accurately located at the centers of the upper bases of the vertical ribs. Accordingly, even if the printing accuracy is unsatisfactory to some extent, the second striped barrier rib material layers can be mounted on the surfaces of the upper bases of the vertical ribs.

As the material of which the second striped barrier rib material layers are composed, either a material identical to the barrier rib material or a material different therefrom is usable. The use of either of the materials allows formation of the exhaustion-use through holes, thereby making it possible to acquire the function of the second striped barrier rib material layers. As having been described above, it is preferable that the barrier rib and the second striped barrier rib material layers are composed of a glass or glass-containing material. In addition to the glass itself, properties of the barrier rib and the second striped barrier rib material layers can be adjusted by doping the glass with ceramics particles or filer of black pigment. The glass or glass-containing material is capable of maintaining the configurations of the barrier rib and the second striped barrier rib material layers when firing the phosphor inside the cells partitioned by the barrier rib.

A material different from the barrier rib material is selected as the glass-containing material of which the second striped barrier rib material layers are composed. Then, the through holes are provided on the horizontal ribs of the lattice-shaped barrier rib, and simultaneously, a different function can be added. For example, electrically conductive property of the second striped barrier rib material layers is adjusted, thereby making it possible to implement effective exchanges of priming particles such as charged particles and excited atoms and molecules between the discharge cells.

A black matrix provided on the plasma display panel is capable of exhibiting an effect of enhancing the contrast of a displayed image. Incidentally, although the black matrix may be provided in a manner of being overlaid on the second striped barrier rib material layers, the second striped barrier rib material layers are also usable as the black matrix. FIG. 4A is a structural schematic diagram in a case where the second striped barrier rib material layers have a black pigment, and the second striped barrier rib material layers have the configuration of partially protruding in the horizontal ribs' direction. FIG. 4B is a structural schematic diagram in a case where the second striped barrier rib material layers have the black pigment, and the second striped barrier rib material layers have the configuration where the widths of the second striped barrier rib material layers are narrower than the widths of the upper bases of the vertical ribs. The use of the black or dark-colored second striped barrier rib material layers results in an effect which is the basically the same as an effect of providing the black matrix on the rear substrate, simultaneously with providing the through holes on the horizontal ribs of the lattice-shaped barrier rib. This result is preferable enough.

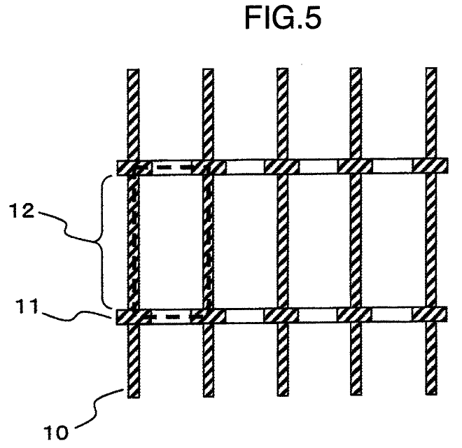

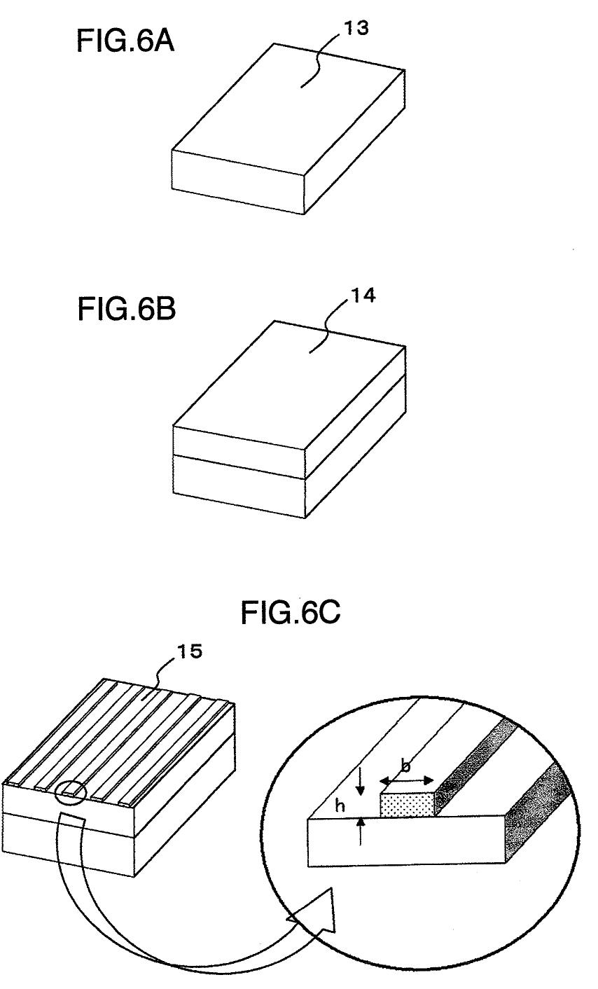

A black or dark-colored glass, or a material formed by mixing a black or dark-color exhibiting inorganic compound with a colorless or light-colored glass is used for the black or dark-colored second striped barrier rib material layers. A vanadium-based glass can be mentioned as the black glass. A commonly known black pigment is usable as the black or dark-color exhibiting inorganic compound. Concretely, there can be mentioned one or more oxides or composite oxides selected from among Fe, Mn, Co, Cu, Cr, Ru, Ti, Ni, Mo, and Nd. As illustrated in FIG. 5, the black matrix in the present embodiment is formed on the side of the rear substrate, is continuous in the address-electrode direction, and is discontinuous in the direction perpendicular to the address electrode.

The width of each stripe-shaped second striped barrier rib material layer 2 formed using the printing method is adjusted within a range which is smaller than each inter-vertical-barrier-ribs pitch. Setting thickness of each stripe-shaped second striped barrier rib material layer 2 (i.e., length of the clearance between the front substrate and the horizontal ribs) at 3 μm or more makes it possible to provide the exhaustion channels which allow implementation of the exhaustion sufficiently. If it is wished to complete the exhaustion in a shorter time and with a higher efficiency, setting the thickness at 10 μm or more is preferable. Cross-sectional area of each through hole provided on the horizontal ribs is given by the following expression:

cross-sectional area of each through hole=((vertical-ribs pitch)−(stripe width))×(stripe thickness).

Thickening the stripe thickness increases the height of each through hole, thereby making it possible to lower the exhaustion resistance. If, however, the size of each through hole provided on the lattice-shaped barrier rib is too large, strength of the lattice-shaped barrier rib lowers. Accordingly, in some cases, the configuration of each through hole cannot be maintained. Meanwhile, if the size is small, the load at the exhaustion step increases, although it becomes easier to ensure the exhaustion channels. Incidentally, the above-described through holes have been provided on the horizontal ribs. The through holes, however, function as the exhaustion channels as well if the through holes are provided on the vertical ribs using the same methodology.

### Embodiment 2

Next, the detailed explanation will be given below concerning the manufacturing method for the lattice-shaped barrier rib of the plasma display panel in the present embodiment. As having been described earlier, this method is equivalent to the following example: A glass-containing material, which becomes the second striped barrier rib material layers, is formed into the stripe-shaped configuration at the positions of the vertical ribs on the coated film of the barrier rib material provided on the glass substrate. After that, the patterning of the lattice-shaped barrier rib is performed. This patterning is performed based on the following method: A photosensitive resist is pasted on the substrate. Moreover, the photosensitive resist is exposed to light, using a mask on which the pattern of the lattice-shaped barrier rib is formed. Furthermore, after developing the exposed resist, the sandblast processing is performed.

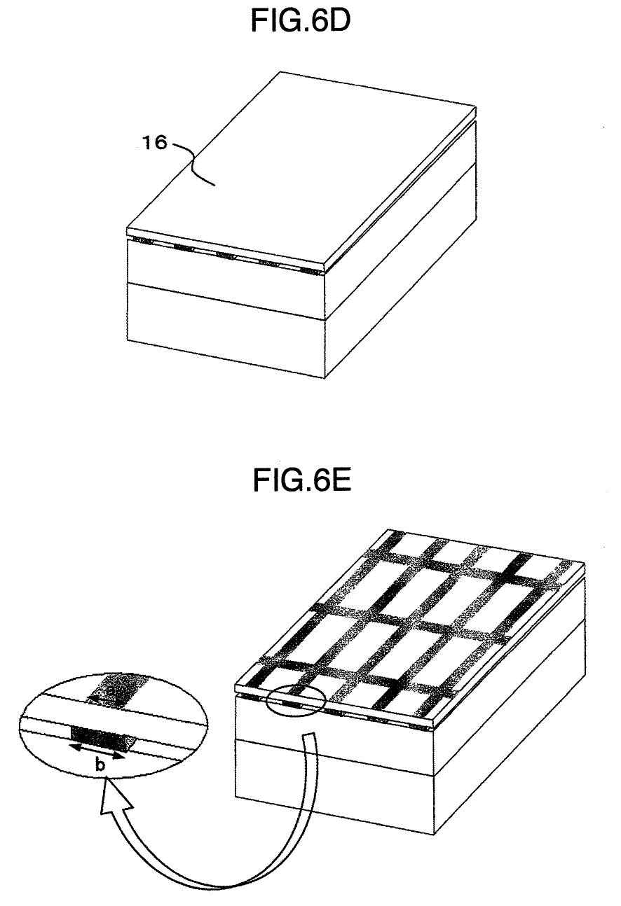

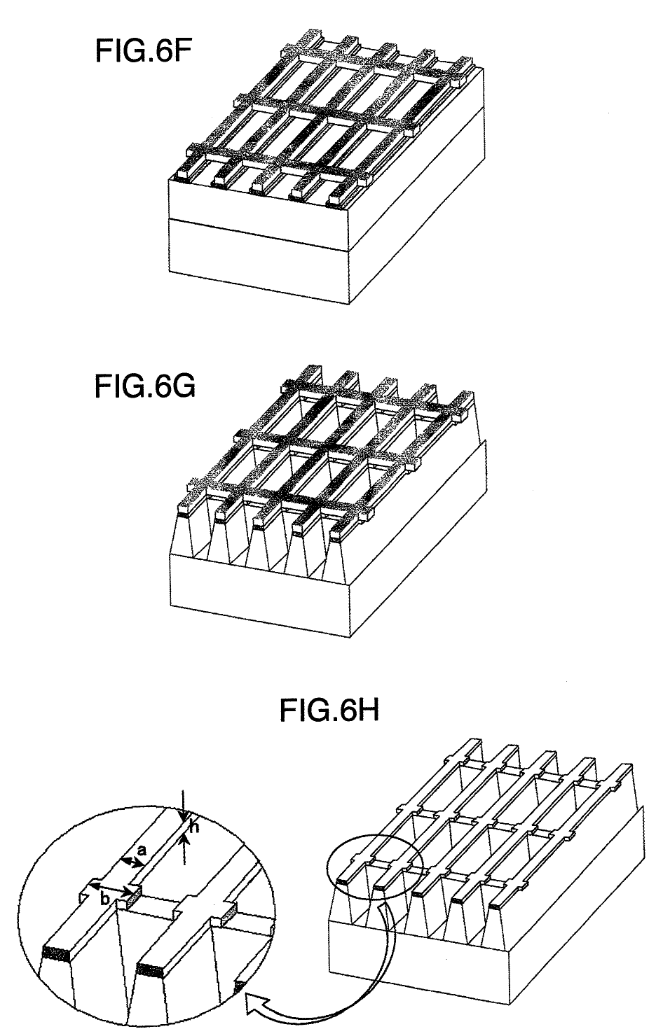

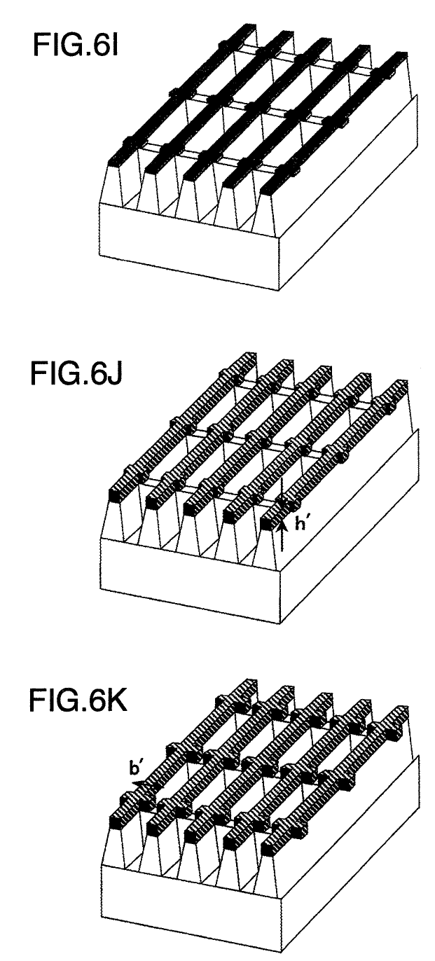

First, as illustrated in FIG. 6B, a first barrier rib material layer 14 is coated on a glass substrate 13 illustrated in FIG. 6A. After drying the first barrier rib material layer 14, as illustrated in FIG. 6C, a second striped barrier rib material layer 15 is printed into a stripe-shaped configuration such that the second striped barrier rib material layer 15 is aligned with positions of the vertical ribs. After that, as illustrated in FIG. 6D, a sandblast-resistant photosensitive resist 16 is pasted thereon. Next, this photosensitive resist 16 is exposed to light, using a mask or the like having the pattern of the lattice-shaped barrier rib (FIG. 6E), then being developed. These processings form the predetermined pattern corresponding to the position configuration of the respective discharge cells as is illustrated in FIG. 6F. Moreover, a portion other than the pattern of the photosensitive resist is erased and removed using the sandblast processing (FIG. 6G), then eliminating the pattern of the photosensitive resist. These processings form a lattice-shaped barrier rib of the profile as is illustrated in FIG. 6H. Here, the method of eliminating the portion other than the pattern of the photosensitive resist is not limited to the sandblast processing, and such methods as a chemical etching method are usable therefor. Also, as illustrated in FIG. 6I, the black matrix can be provided on the top of the lattice-shaped barrier rib by making black the color of the barrier rib's second layer printed into the stripe-shaped configuration.

The width and thickness of each through hole are adjusted by adjusting width b and thickness h of the barrier rib's second layer printed into the stripe-shaped configuration in FIG. 6C. For example, increasing the thickness h illustrated in FIG. 6H up to h′ allows acquisition of the lattice-shaped barrier rib as is illustrated in FIG. 6J. Also, further, increasing the width b illustrated in FIG. 6H up to b′ allows acquisition of the lattice-shaped barrier rib as is illustrated in FIG. 6K.

In the present embodiment, lattice-shaped barrier ribs having six types of concave through holes illustrated on Table 1 are manufactured, thereby making an investigation on exhaustion characteristics of the panels. The width b and thickness h of each second striped barrier rib material layer are varied, setting the width a of each vertical rib at 60 μm and each vertical-ribs pitch at 288 μm. The transparent-tone material, which is the same as the one in the first-layer barrier-rib layer, is used for the material of the lattice-shaped barrier ribs. The barrier ribs having the profiles of RB01 to RB06 are formed using the printing method, then being dried. After that, the barrier ribs are fired in the atmosphere under a condition of 560° C.×30 minutes.

### [Table 1]

TABLE 1

| | second striped barrier rib material | |
|---|---|---|
| | layer's width b (μm) | thickness h (μm) |
| RB01 | 100 | 1 |
| RB02 | 70 | 1 |
| RB03 | 100 | 5 |
| RB04 | 70 | 5 |
| RB05 | 100 | 10 |
| RB06 | 70 | 10 |

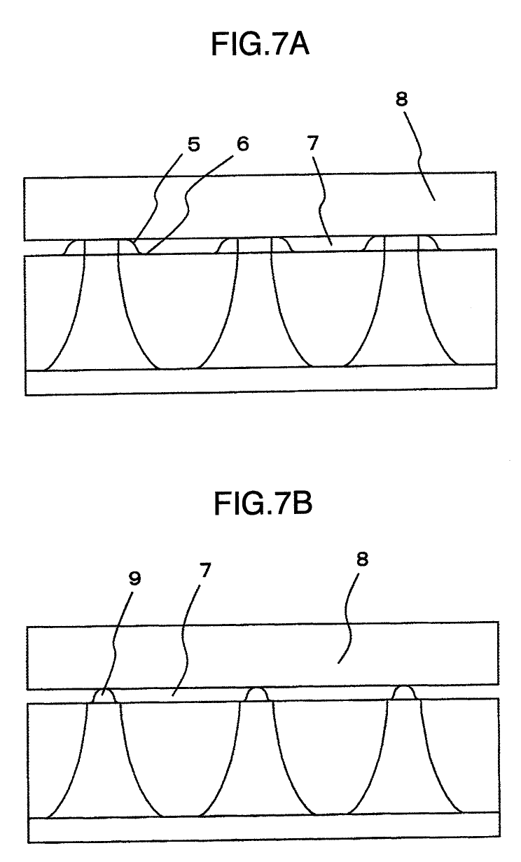

As illustrated in FIG. 2, the profile of each second striped barrier rib material layer on the barrier rib is the cross-sectional configuration having the smooth curvature on the edge surface denoted by the reference numerals 5 and 6. This is the profile obtained at the time when each second striped barrier rib material layer is formed using the printing method with a fluidity-exhibiting paste. The fluid friction is reduced by smoothing surface coarse degree of the edge surface of each through hole 7 which becomes each exhaustion channel at the exhaustion step of the panel. This reduction makes it possible to reduce the pressure loss of air which passes through each exhaustion channel. Namely, there exists an effect of being capable of enhancing attained vacuum degree by enhancing the energy efficiency needed for the exhaustion. In the case where the patterning is performed using the chemical etching method, the configuration of the barrier rib becomes a configuration having arc-like curved surfaces on the wall surface as illustrated in FIG. 7A and FIG. 7B. Accordingly, as is the case with the printing method, there can be obtained the effect of being capable of reducing the pressure loss.

In the present embodiment, 42-type PDP samples have been used, and vacuum degrees inside the panels have been measured using a process in which the sealing/bonding and the air exhaustion are developed simultaneously. Using the respective rear substrates on which the above-described 6 types of barrier ribs are manufactured, a sealing/bonding-use glass paste is coated on the circumferences of the rear substrates, then performing the temporary firing. The sealing/bonding-use glass paste is a Bi-based unleaded glass paste manufactured by Japan Electricity Glass Co., Ltd. The temporary firing temperature has been set at 480° C.

An exhaustion pipe designed for in-panel exhaustion is fixed to the 6 types of barrier ribs, i.e., RB01 to RB06, from the rear substrates after being temporarily fired. Moreover, the front substrates are oppositely located to the rear substrates, then starting the firing of the sealing/bonding-use glass. The firing has been performed with its maximum temperature set at 450° C. The vacuum exhaustion is started 30 minutes after maintenance of the firing at 450° C. is started. Furthermore, the vacuum degrees inside the panels are observed using vacuum gauges which are fixed at the centers of the panels. Schurz gauges have been employed as the vacuum gauges.

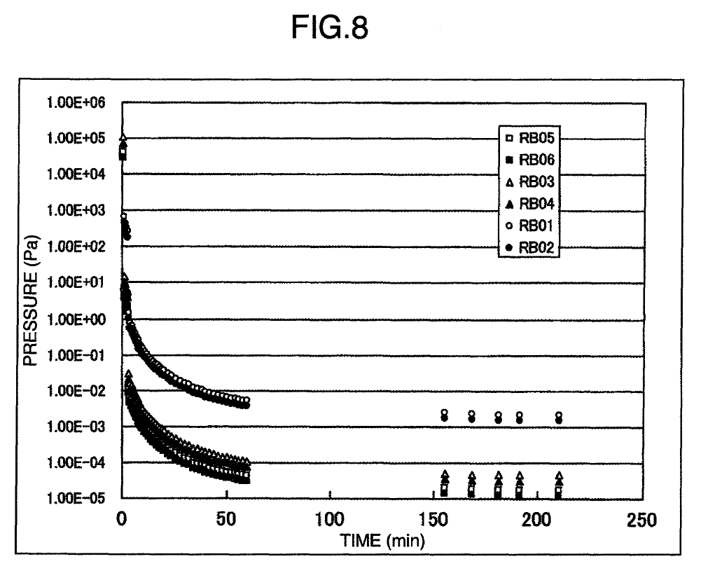

FIG. 8 is a diagram obtained by plotting the vacuum degrees inside the panels as functions of time immediately after the vacuum exhaustion at 450° C. is stated. In the panel where the thickness of the barrier rib's second layer is 10 μm, the vacuum degree has attained to 10⁻⁴ Pa or less fastest of all. Next, the vacuum degree of the panel where the thickness of the barrier rib's second layer is 5 μm has attained to 10⁻⁴ Pa or less. The difference between the times which the vacuum degrees inside both panels have needed in order to attain to 10⁻⁴ Pa or less has been equal to 15 to 35 minutes. Meanwhile, the vacuum degree inside the panel where the thickness of the barrier rib's second layer is 1 μm has been found to be substantially 2×10⁻³ Pa even after the 200-minute exhaustion has been executed. Accordingly, the inventor et al. have judged that an even further time is needed for attaining to the vacuum, and thus have discontinued the test.

As indicated in the present embodiment, the stripe-shaped barrier rib's second layer (i.e., second striped barrier rib material layers) is printed on the barrier rib's first layer. Moreover, the sandblast processing is performed after the patterning of the barrier rib. This method makes it possible to easily provide the exhaustion channels on the horizontal ribs.

### Embodiment 3

Moreover, the width, thickness, and color tone of each second striped barrier rib material layer are varied, thereby prototyping and investigating panels corresponding to the resultant various types of second striped barrier rib material layers. Namely, similarly to the above-described example, barrier ribs are manufactured where each vertical-rib width a is set at 60 μm, and the stripe width b of each second striped barrier rib material layer is varied in the range of 20 to 150 μm, and the stripe thickness h thereof is varied in the range of 3 to 15 μm. Furthermore, barrier ribs having similar profiles are manufactured using a black-pigment containing paste. The overall barrier ribs manufactured in this way correspond to manufactured rear substrates denoted by RB-T-1 to RB-B-20, i.e., 40 samples in total.

Using the respective rear substrates on which the above-described 40 types of barrier ribs are manufactured, a sealing/bonding-use glass paste is coated on the circumferences of the rear substrates, then performing the temporary firing. The sealing/bonding-use glass paste used here, as is the case with the second embodiment, is the Bi-based unleaded glass paste manufactured by Japan Electricity Glass Co., Ltd. The temporary firing temperature has been set at 480° C. An exhaustion pipe is fixed to each of the resultant panels. Then, vacuum degrees inside the panels have been measured using a process in which the sealing/bonding and the air exhaustion are developed simultaneously.

The firing has been performed with its maximum temperature set at 450° C. The vacuum exhaustion is started 15 minutes after maintenance of the firing at 450° C. is started. Furthermore, the vacuum degrees inside the panels are observed using the vacuum gauges (Schurz gauges) which are fixed at the centers of the panels. As a result of the vacuum exhaustion test, notation ◯ is assigned to a panel whose in-panel vacuum degree has attained to 10⁻⁴ Pa or less within 60 minutes, and Δ is assigned to a panel whose in-panel vacuum degree has necessitated 60 minutes or more in order to attain to 10⁻⁴ Pa or less, and × is assigned to a panel whose in-panel vacuum degree has not attained to 10⁻⁴ Pa or less even after a lapse of 200 minutes.

### [Table 2]

TABLE 2

| | width | thickness | | | |
|---|---|---|---|---|---|
| | b | h | | | |
| | (μm) | (μm) | color tone | exhaustion | remarks |
| RB-T-1 | 20 | 3 | transparent | ◯ | second layer |
| RB-T-2 | 40 | | | ◯ | and first layer |
| RB-T-3 | 70 | | | Δ | are formed of |
| RB-T-4 | 100 | | | X | same material |
| RB-T-5 | 150 | | | X | |
| RB-T-6 | 20 | 5 | | ◯ | |
| RB-T-7 | 40 | | | ◯ | |
| RB-T-8 | 70 | | | ◯ | |
| RB-T-9 | 100 | | | ◯ | |
| RB-T-10 | 150 | | | Δ | |
| RB-T-11 | 20 | 10 | | ◯ | |
| RB-T-12 | 40 | | | ◯ | |
| RB-T-13 | 70 | | | ◯ | |
| RB-T-14 | 100 | | | ◯ | |
| RB-T-15 | 150 | | | ◯ | |
| RB-T-16 | 20 | 15 | | ◯ | |
| RB-T-17 | 40 | | | ◯ | |
| RB-T-18 | 70 | | | ◯ | |
| RB-T-19 | 100 | | | ◯ | |
| RB-T-20 | 150 | | | ◯ | |

### [Table 3]

TABLE 3

| | width b | thickness h | color | | |
|---|---|---|---|---|---|
| | (μm) | (μm) | tone | exhaustion | remarks |
| RB-B-1 | 20 | 3 | black | ◯ | second layer |
| RB-B-2 | 40 | | | ◯ | contains |
| RB-B-3 | 70 | | | Δ | Fe—Cr—Mn- |
| RB-B-4 | 100 | | | X | based |
| RB-B-5 | 150 | | | X | black pigment |
| RB-B-6 | 20 | 5 | | ◯ | |
| RB-B-7 | 40 | | | ◯ | |
| RB-B-8 | 70 | | | ◯ | |
| RB-B-9 | 100 | | | ◯ | |
| RB-B-10 | 150 | | | Δ | |
| RB-B-11 | 20 | 10 | | ◯ | |
| RB-B-12 | 40 | | | ◯ | |
| RB-B-13 | 70 | | | ◯ | |
| RB-B-14 | 100 | | | ◯ | |
| RB-B-15 | 150 | | | ◯ | |
| RB-B-16 | 20 | 15 | | ◯ | |
| RB-B-17 | 40 | | | ◯ | |
| RB-B-18 | 70 | | | ◯ | |
| RB-B-19 | 100 | | | ◯ | |
| RB-B-20 | 150 | | | ◯ | |

The cross-sectional area of each through hole formed on the horizontal ribs is given by the following expression:

cross-sectional area of each through hole=((vertical-ribs pitch)−(stripe width b of second striped barrier rib material layer))×(stripe thickness h of second striped barrier rib material layer)

The vertical-ribs pitch in the present embodiment is equal to 288 μm. Accordingly, under a condition of, e.g., the stripe width b=20 μm and the stripe thickness h=5 μm, the cross-sectional area of each through hole becomes equal to

(288−20)×5=1340 μm².

As a result of the present investigation, the following finding has been confirmed: Namely, a through hole functions as an exhaustion channel as long as its cross-sectional area basically exceeds 600 μm². Here, this cross-sectional area is calculated based on the above-described calculation expression. It is needless to say that, with respect to a second striped barrier rib material layer whose stripe sizes are not described in the present embodiment, a through hole corresponding thereto makes it possible to implement the air exhaustion without question if its cross-sectional area exceeds 600 μm².

It should be further understood by those skilled in the art that although the foregoing description has been made on embodiments of the invention, the invention is not limited thereto and various changes and modifications may be made without departing from the spirit of the invention and the scope of the appended claims.

1. A method of manufacturing a plasma display panel, said plasma display panel including a pair of oppositely located to each other, and a lattice-shaped barrier rib provided between said substrates and maintaining a clearance between said substrates,
said method, comprising the steps of:
providing a first barrier rib material layer on a glass substrate,
providing a second striped barrier rib material layers on said first barrier rib material layer, and
forming a configuration of lattice-shaped barrier rib by eliminating unnecessary part of said two barrier rib material layers.

2. The method according to claim 1, wherein
said step of forming the configuration of lattice-shaped barrier rib is a sandblast method or a chemical etching method.

3. The method according to claim 1, wherein
said second striped barrier rib material layers are overlaid on positions at which vertical ribs are to be formed,
width of said stripe-shaped configuration being wider than width of an upper base of each of said vertical ribs.

4. The method according to claim 1, wherein
said second striped barrier rib material layers are overlaid on positions at which vertical ribs are to be formed,
width of said stripe-shaped configuration being narrower than width of an upper base of each of said vertical ribs.

5. The method according to claim 1, wherein
said second striped barrier rib material layers are composed of a glass-containing material,
the second striped barrier rib material layers are overlaid on positions at which vertical ribs are to be formed, width of said stripe-shaped configuration being wider than width of an upper base of each of said vertical ribs,
said step of forming said configuration of said lattice-shaped barrier rib, comprising the steps of:
pasting a photosensitive resist on said the second striped barrier rib material layers,
exposing to light and developing said photosensitive resist using a mask for lattice-shaped pattern, and
performing a sandblast processing using said photosensitive resist on which said pattern of said lattice-shaped barrier ribs is formed.

6. The method according to claim 1, wherein
said second striped barrier rib material layers are composed of a material which is the same as said material of said the first barrier rib material layer.

7. The method according to claim 1, wherein
said second striped barrier rib material layers are composed of a material which is different from said material of the first barrier rib material layer.

8. The method according to claim 1, wherein
a glass containing a black or dark-color exhibiting inorganic compound is used as the second striped barrier rib material.

9. A plasma display panel where a front substrate are oppositely located to each other,
said front substrate including a plurality of electrodes, and a dielectric layer which is so formed as to cover said plurality of electrodes,
said rear substrate including address electrodes, and a lattice-shaped barrier rib which partitions discharge cells,
said lattice-shaped barrier rib, comprising:
vertical ribs which are parallel to said address electrodes, and
horizontal ribs which are perpendicular to said address electrode, and whose heights are equal to heights of said vertical ribs, wherein
second striped barrier rib material layers are provided on said vertical ribs.

10. The plasma display panel according to claim 9, wherein
each of said stripe-shaped configuration has protrusion portions which protrude partially onto each of said horizontal ribs,
said protrusion portions having a curved surface at edge portions of said protrusion portions.

11. The plasma display panel according to claim 9, wherein
width of each of said stripe-shaped configuration is narrower than width of an upper surface of each of said vertical ribs,
an upper surface of each of the second striped barrier rib material layers having a configuration where an upper portion of a central portion of each of said vertical ribs is higher.

12. The plasma display panel according to claim 9, wherein
said second striped barrier rib material layers are composed of a glass-containing material, said glass-containing material being a material which is the same as the first barrier rib material layer.

13. The plasma display panel according to claim 9, wherein
said second striped barrier rib material layers are composed of a glass-containing material, said glass-containing material being a material which is different from the first barrier rib material layer.

14. The plasma display panel according to claim 12, wherein
said second striped barrier rib material layers are composed of a glass, said glass containing a black or dark-color exhibiting inorganic compound.

15. The plasma display panel according to claim 14, wherein
said inorganic compound contains an oxide of any one of, or a composite oxide of Fe, Mn, Co, Cu, Cr, Ru, Ti, Ni, Mo, and Nd.

16. The plasma display panel according to claim 9, wherein
thickness of each second striped barrier rib material layers is equal to 10 μm or more.

17. The plasma display panel according to claim 9, wherein
said second striped barrier rib material layers are continuous in said direction of said address electrode, and are discontinuous in said direction perpendicular to said address electrode.

18. A plasma display panel where a front substrate and a rear substrate are oppositely located to each other,
said front substrate including a plurality of electrodes, and a dielectric layer which is so formed as to cover said plurality of electrodes,
said rear substrate including an address electrode, and a lattice-shaped barrier rib which partitions discharge cells,
said lattice-shaped barrier rib, comprising:
vertical ribs which are parallel to said address electrode, and
horizontal ribs which are perpendicular to said address electrode, wherein
each of said horizontal ribs comprises concave portions whose heights are lower than heights of said vertical ribs,
through holes being located in parallel with said vertical ribs, said through holes being formed by said concave portions and said front substrate,
said lattice-shaped barrier rib surface of each of said through holes being formed into a surface which has a curvature toward inside of each of said through holes.

19. The plasma display panel according to claim 9, wherein
said rear substrate comprises a black matrix,
said black matrix having a configuration where said black matrix is continuous in said direction of said address electrode, and is discontinuous in said direction perpendicular to said address electrode.
